(19) United States
(12) Patent Application Publication
(10) Pub. No.: US 2023/0049997 A1
(43) Pub. Date: Feb. 16, 2023

(54) LARGE-COOLING-CAPACITY INTEGRATED STIRLING PNEUMATIC REFRIGERATOR SUPPORTED BY LARGE-STROKE COLUMN SPRINGS

(71) Applicant: Shanghai Institute of Technical Physics of the Chinese Academy of Sciences, Shanghai (CN)

(72) Inventors: Zhenhua JIANG, Shanghai (CN); Yinong WU, Shanghai (CN); Zheng HUANG, Shanghai (CN); Wencui WU, Shanghai (CN); Danfeng SHANG, Shanghai (CN); Chuan CHEN, Shanghai (CN); Xiaoping QU, Shanghai (CN)

(73) Assignee: Shanghai Institute of Technical Physics of the Chinese Academy of Sciences, Shanghai (CN)

(21) Appl. No.: 17/812,298

(22) Filed: Jul. 13, 2022

(30) Foreign Application Priority Data
Aug. 13, 2021 (CN) 202110930630.9

(51) Int. Cl. F16F 15/023; F25B 9/14

(52) U.S. Cl. CPC F16F 15/0232; F25B 9/14; F25B 2309/14; F16F 2232/08; F16F 2230/0029

(57) ABSTRACT

A large-cooling-capacity integrated Stirling pneumatic refrigerator supported by large-stroke column springs, consisting of an active vibration absorber, a motor, a coaxial type compression-expansion piston, a compression piston column spring, an expansion piston column spring, a hot-end radiator, a cylinder wall, a housing, and a cold finger, wherein the coaxial compression-expansion piston is composed of a compression piston and an expansion piston, the expansion piston is nested in the compression piston, and the compression piston and the expansion piston share one hot-end radiator; the compression piston is driven by a motor, and the expansion piston is driven by gas force and no motor drive is required. The compression piston and the expansion piston are both supported by column springs, the column spring provides an axial restoring force for the coaxial type compression-expansion piston. The active vibration absorber is installed at the tail part of the housing.

### CROSS REFERENCE TO RELATED APPLICATION(S)

This patent application claims the benefit and priority of Chinese Patent Application No. 202110930630.9, filed on Aug. 13, 2021, the disclosure of which is incorporated by reference herein in its entirety as part of the present application.

### TECHNICAL FIELD

The present disclosure relates to the field of refrigerators, and in particular relates to a large-cooling-capacity integrated Stirling pneumatic refrigerator supported by large-stroke column springs.

### BACKGROUND ART

At present, an existing space regenerative refrigerator is mainly supported by a flexure spring. Due to the constraint of the fatigue stress limit, the axial stroke of the flexure plate spring is generally small, the existing refrigerator generally employs a large piston diameter to achieve large refrigerating capacity, resulting in heavy weight and large volume of the refrigerator. In addition, most of existing space-borne Stirling cryogenic refrigerators are arranged in a split mode, and radial vibration thereof is large due to asymmetric radial gas force. Due to the coaxial layout, the gas force of the integrated cryogenic refrigerator can achieve radial symmetry, but most of the integrated refrigerators employ a moving-magnetic type linear motor which is compact in structure and high in efficiency, for example, a flutter force test conducted on a GT refrigerator of SunPower by Ball company shows that the vibration output of passive vibration reduction is 28 N, even if the active vibration reduction is adopted, the vibration output still reaches 19 N, the reason is that a moving part of the moving-magnetic type linear motor is a permanent magnet, and the radial flutter of the moving permanent magnet is large due to large radial bias force of the moving permanent magnet. In the present disclosure, the axial restoring force is achieved by connecting the coaxial type compression-expansion piston by column springs, thus the large-stroke movement of the small piston can be achieved, and large-cooling-capacity refrigeration can be achieved under small refrigerator volume; an air bearing is adopted for main radial supporting to achieve long-service-life and abrasion-free operation; the compression piston is driven by a moving-coil type motor, and the vibration of the moving-coil type motor is much less than that of the moving-magnetic type motor. The present disclosure may achieve the advantages of large cooling capacity, small size, low vibration, and long service life.

### SUMMARY

The technical problem to be solved by the present disclosure is that the Stirling refrigerator is low in integration degree, high in vibration, less in cooling capacity, and small in stroke. For the technical problem, a large-cooling-capacity integrated Stirling pneumatic refrigerator supported by large-stroke column springs is provided.

The technical solution provided by the present disclosure is as follows: a large-cooling-capacity integrated Stirling pneumatic refrigerator supported by large-stroke column springs comprises an active vibration absorber 1, a motor 2, a coaxial type compression-expansion piston 3, a compression piston column spring 4, an expansion piston column spring 5, a hot-end radiator 6, a cold finger 8, a housing 7, and a cylinder wall 9.

The active vibration absorber 1 is connected to the tail part of the housing 7; a compression piston 3-1 and an expansion piston 3-2 are coaxially arranged and share one hot-end radiator 6; the motor 2 wraps the periphery of the cylinder wall 9, and the motor 2 is connected to the compression piston 3-1 through a coil connecting block 2-1.

Wherein the motor 2 is a moving-coil type motor, and comprises the coil connecting block 2-1, a magnetic pole 2-2, magnetic steel 2-3, and a moving coil 2-4; the coil connecting block 2-1 is connected to the moving coil 2-4; and the magnetic steel 2-3 is connected to the magnetic pole 2-2. A moving-coil type coil mover is not affected by magnetic attraction force, and thus there is no radial bias force theoretically.

The coaxial type compression-expansion piston 3 comprises the compression piston 3-1 and the expansion piston 3-2. Wherein the compression piston 3-1 and the expansion piston 3-2 of the coaxial type compression-expansion piston 3 are coaxially arranged, and the expansion piston 3-2 is nested in the compression piston 3-1 to reduce the radial force to the greatest extent.

The compression piston 3-1 is supported by an air bearing, and comprises a compression piston body 3-1-1, a compression piston gas path 3-1-2, a compression piston throttle hole 3-1-3, and a compression piston check valve 3-1-4.

The expansion piston 3-2 is supported by an air bearing, and comprises an expansion piston body 3-2-1, an expansion piston throttle hole 3-2-2, an expansion piston gas path 3-2-3, and an expansion piston check valve 3-2-4.

Compared with the prior art, the present disclosure has the beneficial effects that:

the expansion piston 3-2 is nested in the compression piston 3-1 to achieve integrated arrangement of the expansion piston 3-2 and the compression piston 3-1. The active vibration absorber 1 is installed at the tail part of the housing 7, and is installed in coaxial with the compression piston 3-1 and the expansion piston 3-2, thus conducting high-order active vibration reduction on the vibration output of the refrigerator. The moving-coil type linear motor has the advantages of being small in mass and low in vibration, and the additional air bearing provides the main radial bearing force to achieve an abrasion-free and long-service-life operation. The compression piston 3-1 is supported by a compression piston column spring 4, and the expansion piston 3-2 is supported by an expansion piston column spring 5; the column springs provide an axial restoring force for the coaxial type compression-expansion piston 3 to ensure the large axial movement stroke of the compression piston 3-1 and the expansion piston 3-2 and to achieve the large refrigerating capacity of the refrigerator. The large-cooling-capacity integrated Stirling pneumatic refrigerator supported by large-stroke column springs provided by the present disclosure has the advantages of being high in integration degree, low in vibration, large in stroke, and large in cooling capacity.

### BRIEF DESCRIPTION OF THE DRAWINGS

FIG. 1 is a structure diagram of the present disclosure;

FIG. 2 is a structure diagram of an active vibration absorber;

FIG. 3 is a structure diagram of a motor;

FIG. 4 is a structure diagram of a coaxial type compression-expansion piston;

FIG. 5 is a structure diagram of a compression piston;

FIG. 6 is a structure diagram of an expansion piston;

In the drawings: 1—active vibration absorber; 2—motor; 2-1—coil connecting block; 2-2—magnetic pole; 2-3—magnetic steel; 2-4—moving coil; 3—coaxial type compression-expansion piston; 3-1—compression piston; 3-1-1—compression piston body; 3-1-2—compression piston gas path; 3-1-3—compression piston throttle hole; 3-1-4—compression piston check valve; 3-2—expansion piston; 3-2-1—expansion piston body; 3-2-2—expansion piston throttle hole; 3-2-3—expansion piston gas path; 3-2-4—expansion piston check valve; 4—compression piston column spring; 5—expansion piston column spring; 6—hot-end radiator; 7—housing; 8—cold finger; 9—cylinder wall.

### DETAILED DESCRIPTION OF THE EMBODIMENTS

One embodiment of the present disclosure is introduced below with reference to the accompanying drawings of the present disclosure:

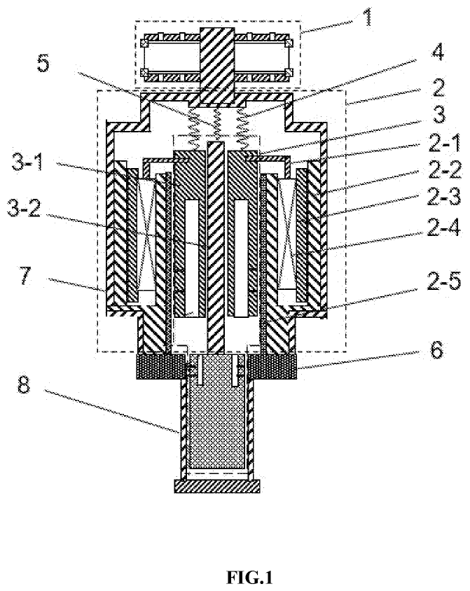

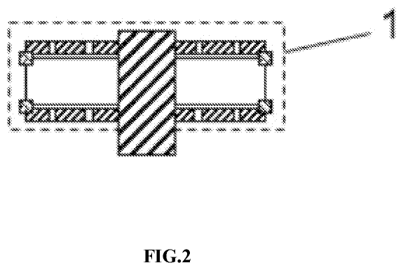

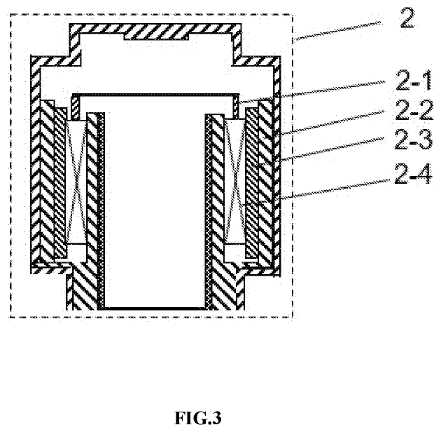

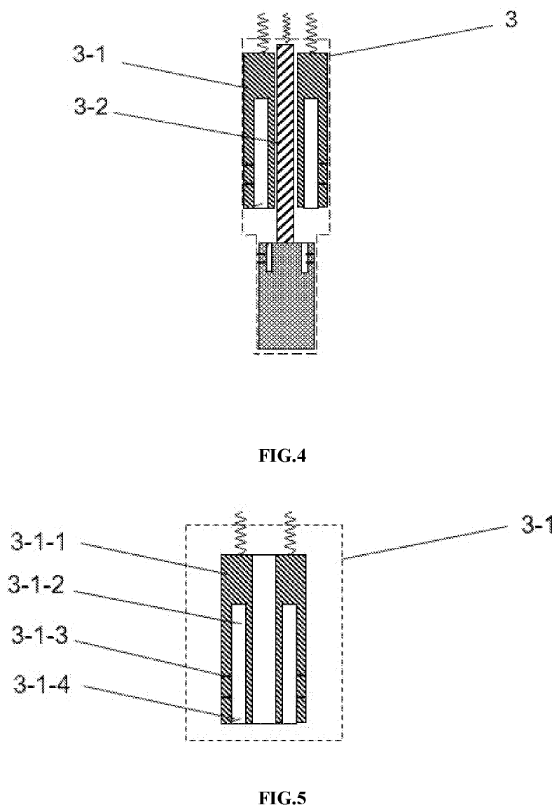

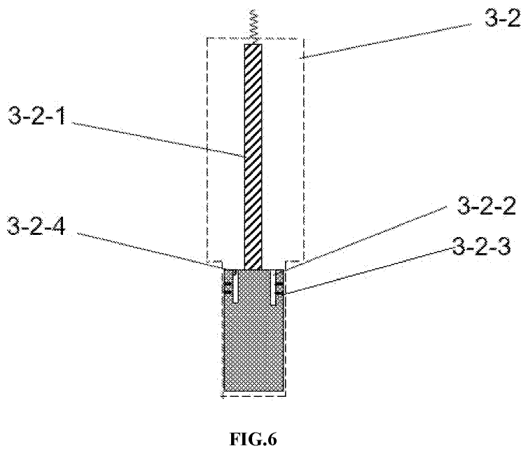

as shown in FIG. 1 to FIG. 6, the embodiment discloses a 30 W@80K large-cooling-capacity integrated Stirling pneumatic refrigerator supported by large-stroke column springs. A compressor inputs electric work of more than 400 W, the Stirling pneumatic refrigerator comprises an active vibration absorber 1, a motor, 2, a coaxial type compression-expansion piston 3, a compression piston column spring 4, an expansion piston column spring 5, a hot-end radiator 6, a housing 7, a cold finger 8, and a cylinder wall 9.

The active vibration absorber 1 is connected to the tail part of the housing 7, a compression piston 3-1 and an expansion piston 3-2 are coaxially arranged and share one hot-end radiator 6; the overall refrigerator is coaxially arranged; thus, the gas is uniformly distributed in the axial direction, no radial component exists, and the radial flutter force is small.

The compression piston 3-1 has a diameter of φ24 mm and is connected to a column spring, and the column spring may reach a unilateral stroke of 15 mm within the allowable stress range. The expansion piston 3-2 has a diameter of φ20 mm and is connected to a column spring, and the column spring may reach a unilateral stroke of 6 mm within the allowable stress range.

The motor 2 is a moving-coil type motor, wraps the periphery of the cylinder wall 9, and is connected to the compression piston 3-1 through a coil connecting block 2-1, wherein a magnetic pole 2-2 and magnetic steel 2-3 are annularly fixed to the inner wall of the housing 7 to generate a constant magnetic field; the moving coil 2-4 is connected to the compression piston 3-1; and when single-phase alternating current is introduced into the moving coil 2-4, alternating electromagnetic force is generated, and the moving coil 2-4 can move under the action of the magnetic field, thus driving the compression piston 3-1 to realize circular reciprocating motion, and making a gas working medium be expanded and compressed.

The compression piston 3-1 and the expansion piston 3-2 of the coaxial type compression-expansion piston 3 are integrally arranged, and the expansion piston 3-2 is nested in the compression piston 3-1 to reduce the radial force to the greatest extent.

Those skilled in the art should know that the embodiments of the present disclosure have been described in detail based on the above drawings, the present disclosure is not limited to above embodiments, and without departing from the principle and spirit of the present disclosure, the corresponding changes, improvements, and optimizations of the present disclosure are within the scope of protection of the present disclosure.

What is claimed is:

1. A large-cooling-capacity integrated Stirling pneumatic refrigerator supported by large-stroke column springs, comprising an active vibration absorber (1), a motor (2), a coaxial type compression-expansion piston (3), a compression piston column spring (4), an expansion piston column spring (5), a hot-end radiator (6), a housing (7), a cold finger (8), and a cylinder wall (9), wherein
the active vibration absorber (1) is connected to the tail part of the housing (7); the top of the motor (2) is connected to a compression piston (3-1), the inner side of the motor (2) is connected to the cylinder wall (9), and the external of the motor (2) is connected to the housing (7); one end of the compression piston column spring (4) is connected to the housing (7), and the other end of the compression piston column spring is connected to the compression piston (3-1); one end of the expansion piston column spring (5) is connected to an expansion piston (3-2), and the other end of the expansion piston column spring is connected to the housing (7); one end of the hot-end radiator (6) is connected to the housing (7) and the cylinder wall (9), and the other end of the hot-end radiator is connected to the cold finger (8).

2. The large-cooling-capacity integrated Stirling pneumatic refrigerator supported by large-stroke column springs according to claim 1, wherein the active vibration absorber (1) is driven by a moving-coil type linear motor.

3. The large-cooling-capacity integrated Stirling pneumatic refrigerator supported by large-stroke column springs according to claim 1, wherein the motor (2) is a moving-coil type motor, and comprises a coil connecting block (2-1), a magnetic pole (2-2), magnetic steel (2-3), and a moving coil (2-4); one end of the coil connecting block (2-1) is connected to the moving coil (2-4), and the other end of the coil connecting block is connected to the compression piston (3-1); and the magnetic steel (2-3) is connected to the magnetic pole (2-2).

4. The large-cooling-capacity integrated Stirling pneumatic refrigerator supported by large-stroke column springs according to claim 1, wherein the coaxial type compression-expansion piston (3) comprises the compression piston (3-1) and the expansion piston (3-2), the compression piston (3-1) and the expansion piston (3-2) in the coaxial type compression-expansion piston (3) are integrally arranged, and the expansion piston (3-2) is nested in the compression piston (3-1).

5. The large-cooling-capacity integrated Stirling pneumatic refrigerator supported by large-stroke column springs according to claim 4, wherein the compression piston (3-1) is supported by an air bearing, and comprises a compression piston body (3-1-1), a compression piston gas path (3-1-2), a compression piston throttle hole (3-1-3), and a compression piston check valve (3-1-4).

6. The large-cooling-capacity integrated Stirling pneumatic refrigerator supported by large-stroke column springs according to claim 4, wherein the expansion piston (3-2) is supported by an air bearing, and comprises an expansion piston body (3-2-1), an expansion piston throttle hole (3-2-2), an expansion piston gas path (3-2-3), and an expansion piston check valve (3-2-4).
